(19) United States
(12) Patent Application Publication
(10) Pub. No.: US 2006/0010087 A1
(43) Pub. Date: Jan. 12, 2006

(54) Sharging method and charging system

(76) Inventor: Wataru Karasawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/527,196

(22) PCT Filed: Sep. 11, 2003
(86) PCT No.: PCT/JP03/11628

§ 371 Date: Mar. 10, 2005

(30) Foreign Application Priority Data
Sep. 11, 2002 (JP) 2002-265664

(51) Int. Cl. G06F 17/00

(52) U.S. Cl. 705/500

(57) ABSTRACT

A business practitioner who offers a maintenance service for a machine (15) quantifies the productivity of the machine (15) in a predetermined service period (S42). The business practitioner compares the quantified productivity with a predetermined productivity reference, and calculates the difference between them (S43). The business practitioner determines a charge amount for the maintenance service in the service period based on the calculated difference (S45). Due to this, charging is realized which can satisfy both of the user of the machine (15) and the maintenance business practitioner.

### TECHNICAL FIELD

The present invention relates to a charging method and charging system for a maintenance service for manufacturing machines.

### BACKGROUND ART

In recent years, due to remarkable progresses in technologies and more and more heated competition between makers for product development, kinds of products manufactured by the makers increase while the life cycles of such products are shortened. Under such circumstance, the makers are required to establish a manufacturing system adaptable to so-called multi-kind in small quantity manufacturing, where products can be manufactured in quick response to the needs of the society and customers.

It is effective to maintain the productivity of manufacturing machines high in order to establish such a manufacturing system as described above. For example, if a product can be manufactured in quick response when there is a sudden request for such manufacturing, loss of opportunity can be avoided and customer satisfaction can be improved. As an index for the productivity of machines, Availability can be used.

Availability is represented by {(Operations Time)−(Downtime)}/(Operations Time)×100. The Operations Time corresponds to a time obtained by subtracting Non-Scheduled Time from an opening time of a plant where the machines are installed. The Downtime consists of a Scheduled Downtime for a regular checkup, etc. and an Unscheduled Downtime caused by an unexpected trouble. From the formula, it is effective to shorten the Downtime in order to achieve a high Availability.

Maintenance is indispensable in order to keep the Availability of machines at a predetermined level. Maintenance of machines is carried out as a free service by a vendor who provides the machines or a business practitioner (hereinafter referred to as business practitioner or the like) who is entrusted by the vendor. In such a case, the maintenance service is fulfilled such that the machines satisfy the Availability arranged between the maker and the business practitioner or the like. Accordingly, it can be said that the machines operate with a predetermined Availability and their productivities remain constant during the maintenance service.

In recent years, there has been developed a system capable of improving the productivity by maintenance. In such a system, the maker (the user of the machines) and the vendor perform the maintenance in cooperation. Specifically, the vendor acquires operational information of the machines from a remote place through a communication network to grasp the operational condition of the machines in real time as well as the maker, and performs the necessary maintenance work in cooperation with the user. By the user and the vendor sharing information on the machines and performing the maintenance work based on the information in cooperation, the efficiency of the work is increased. This makes it possible to improve the Availability of the machines, due to shortening of the Unscheduled Downtime achieved by a quick recovery from a trouble, etc.

Further, in the above system, the vendor acquires information on replacement of components of the machines such as the useful cycle of the components, etc. together with the operational information. The vendor calculates the optimum replacement cycle for the components based on the acquired information, and feeds the calculated replacement cycle back to the user. This enables the user to efficiently carry out the components replacement, and leads to improvement of the Availability due to a substantial reduction in the Scheduled Downtime of the machines, etc.

As such, according to the above-described method, it is possible to improve the Availability of the machines during the maintenance period, i.e. to improve the productivity, and sometimes it may be possible to realize a higher productivity (Availability) than a value preset in a maintenance contract or the like. In such a case, it can be said that the vendor offers not only the “maintenance” work, but also an “improvement” work.

Incidentally, the maintenance service offered by the business practitioner or the like is normally not free of charge, but requires a payment from the user (maker). For example, the business practitioner or the like charges the user a predetermined amount of payment for a predetermined work, or charges the user an amount of payment in proportion to the time required for the maintenance work. Unexamined Japanese Patent Application KOKAI Publication No. 2002-117336 discloses a method for charging for the actual operational output of the machines, such as the number of wafers processed, etc.

However, these conventional charging methods are applicable to the maintenance service for realizing a predetermined productivity while aiming at a preset Availability, etc. as the index, and not applicable to charging for the above-described “improvement” work separately from the other “maintenance” work. Because of this, in a case where the amount to be charged is determined by simply using the conventional charging method, the business practitioner or the like and the user can neither be satisfied for the following reasons.

First, the business practitioner or the like who offers the service is required to have a system which is prepared for the cooperative work with the user in real time, which increases the financial burden. Therefore, it is reasonable for the vendor or the like to require the payment for the “improvement” work other than the payment for the conventional “maintenance” work, when they require the payment for the maintenance.

On the other hand, the user can receive the benefit of a reduction in the manufacturing cost, etc. due to the improved productivity of the machines. Therefore, the user may not complain about paying for the “improvement” work. However, the Operations Time is not equal to the manufacturing time depending upon the condition of orders received, etc., and a simple increase in the charged amount is not acceptable for the user because it increases the manufacturing cost.

From these aspects, a charging method is demanded which can quantitatively charge for the work contributing to the improvement of the productivity (improvement work) in the maintenance work, and which can satisfy both the user and the maintenance business practitioner. However, there has been no such method.

In view of the above circumference, the object of the present invention is to provide a charging method and charging system capable of satisfying both the user of the machines and the maintenance business practitioner.

### DISCLOSURE OF THE INVENTION

To achieve the above object, the following invention is disclosed in accordance with the principle of the present invention.

A charging method according to a first aspect of the present invention is a charging method for determining an amount of payment for a maintenance service for a machine, comprising:

a quantifying step of quantifying productivity of the machine in a predetermined service period;

a comparing step of comparing the productivity quantified in said quantifying step with a predetermined productivity reference and calculating a difference between them; and

a charge amount determining step of determining a charge amount for the maintenance service in the service period based on the difference calculated in the comparing step.

The charging method having the above-described structure may comprise a productivity reference determining step of determining the productivity reference by operating the machine during a predetermined preliminary period and quantifying productivity of the machine in the preliminary period.

In the charging method having the above-described structure, the productivity of the machine is quantified based on at least one of, for example, Availability, Uptime, and an amount of production in the quantifying step.

In the charging method having the above-described structure, the charge amount may be determined by multiplying the calculated difference by a predetermined conversion rate in the charge amount determining step.

A charging system according to a second aspect of the present invention is a charging system for determining an amount of payment for a maintenance service for a machine, comprising:

quantifying means for quantifying productivity of the machine in a predetermined service period;

comparing means for comparing the quantified productivity with a predetermined productivity reference and calculating a difference between them; and

charge amount determining means for determining a charge amount for the maintenance service in the service period based on the calculated difference.

The charging system having the above-described structure may comprise productivity reference determining means for determining the productivity reference by operating the machine during a predetermined preliminary period and quantifying productivity of the machine in the preliminary period.

In the charging system having the above-described structure, the quantifying means quantifies the productivity of the machine based on at least one of, for example, Availability, Uptime, and an amount of production.

In the charging system having the above-described structure, the charge amount determining means may determine the charge amount by multiplying the calculated difference by a predetermined conversion rate.

### BRIEF DESCRIPTION OF THE DRAWINGS

FIG. 1 is a diagram showing the structure of a charging system according to an embodiment of the present invention;

FIG. 2 is a diagram showing an example of the structure of a machine;

FIG. 3 is a diagram showing the structure of a plant computer;

FIG. 4 is a diagram showing the structure of a business practitioner computer;

FIG. 5 is a diagram showing an example of operational condition data stored in a machine information DB;

FIG. 6 is a diagram showing an example of maintenance data stored in the machine information DB;

FIG. 7 is a diagram showing an example of data stored in a profile information DB;

FIG. 8 is a diagram showing an example of data stored in the profile information B;

FIG. 9 is a diagram showing an example of data stored in a contact destination information DB;

FIG. 10 is a diagram showing an example of data stored in a component information DB;

FIG. 11 is a diagram showing an example of data stored in a charging information DB;

FIG. 12 is a diagram showing an example of a flow of a charging operation;

FIG. 13 is a diagram showing an example of a flow of a maintenance and monitoring operation;

FIG. 14 is a diagram showing an example of a flow of a replacement cycle calculating operation;

FIG. 15 is a diagram showing an example of a flow of a charge amount determining operation; and

FIG. 16 is a diagram showing an example of a bill.

### BEST MODE FOR CARRYING OUT THE INVENTION

A charging system and charging method for charging for a maintenance service for a manufacturing machine according to the present embodiment will now be explained with reference to the drawings.

In the present embodiment, the manufacturing machine is a semiconductor manufacturing apparatus, which is used by a semiconductor device maker, i.e. the user in their plant. The maintenance service for the machine is offered by the vendor who provides the machine, or a business practitioner who is entrusted by the vendor (hereinafter referred to as business practitioner), and the business practitioner charges the user for the service offered.

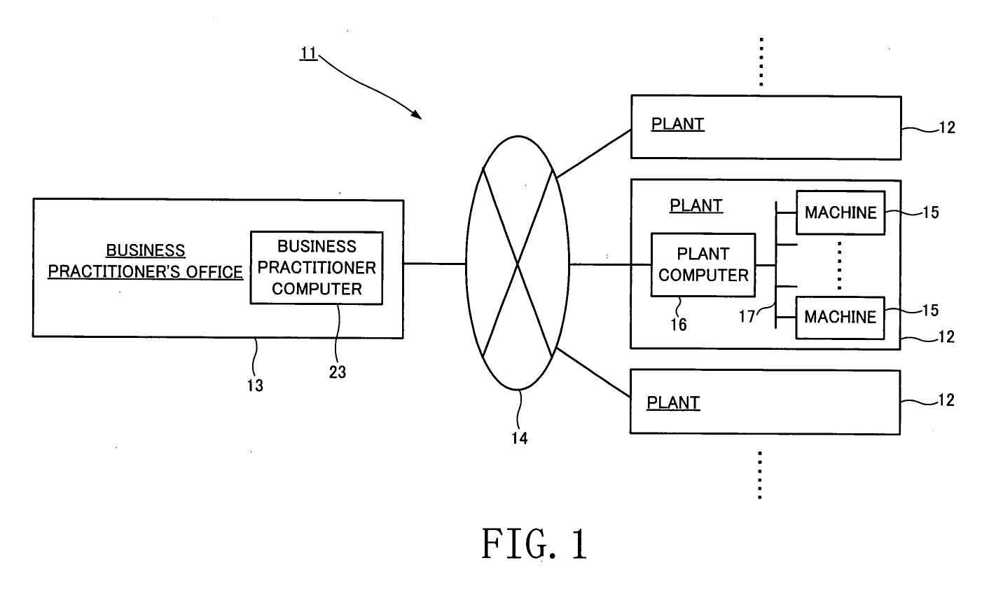

FIG. 1 shows the structure of a charging system 11 according to the present embodiment.

As shown in FIG. 1, the charging system 11 of the present embodiment is structured such that one or a plurality of plants 12 of one or a plurality of users is/are connected to a business practitioner's office 13 of the business practitioner of the service via a communication line 14.

The communication line 14 is constituted by, for example, the Internet. The communication line 14 may be constituted by any of a private line, a public line network, an ISDN network, a cable broadcasting network, a radio communication network, a satellite communication network, etc. or a combination of these.

In the plant 12, one or a plurality of machines 15 and a plant computer 16 are installed. The machine 15 and the plant computer 16 are connected via an intra-plant wire network 17 such as a LAN (Local Area Network) or the like. The plant computer 16 collectively manages the machine 15 used in the plant 12.

The machine 15 is an apparatus used for manufacturing an electronic device such as a semiconductor device, a liquid crystal display device, etc., and may be, for example, a prior step machine 15 (a film forming apparatus, a thermal processing apparatus, etc.) or a posterior step machine 15 (a mounting apparatus, a testing apparatus, etc.). One or plural kinds of machines 15 is/are installed in one plant 12.

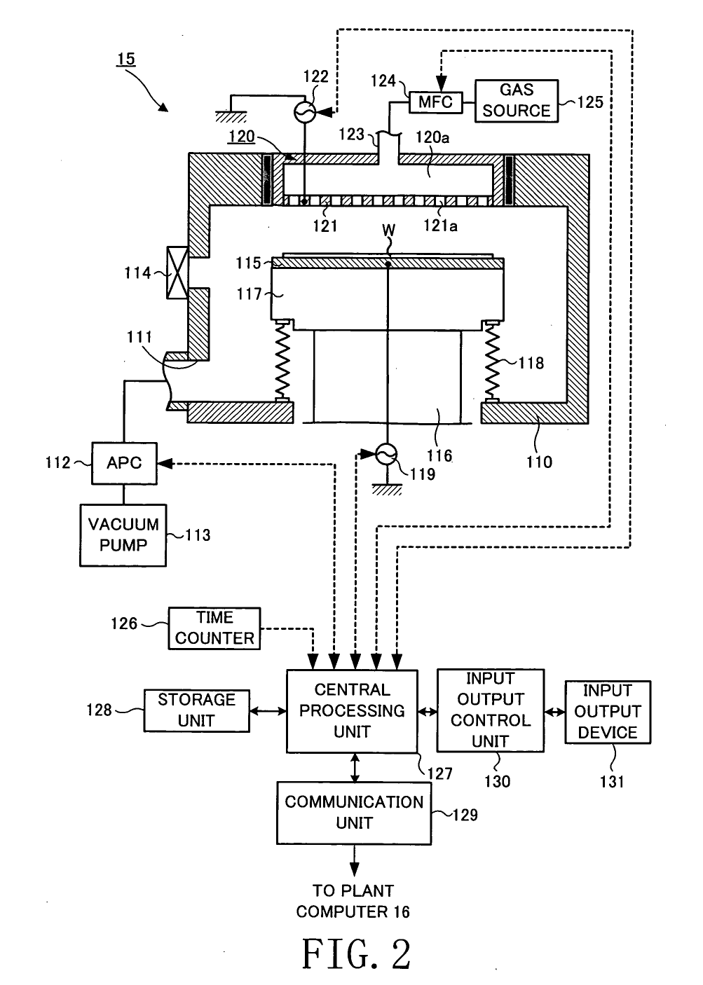

FIG. 2 shows the structure of the machine 15. In FIG. 2, a case where a single wafer plasma CVD apparatus is used as the machine 15 will be explained as an example.

As shown in FIG. 2, the machine 15 comprises a chamber 110 formed into a cylindrical shape 110.

An exhaust port 111 is formed in the side wall of the chamber 110. An vacuum pump 113 is connected to the exhaust port 111 via an APC (Automatic Pressure Controller) 112. The vacuum pump 113 is constituted by a turbo molecular pump or the like, and evacuates the interior of the chamber 110 to a predetermined reduced pressure atmosphere. A gate valve 114 is provided on the side wall of the chamber 110, and a wafer W is transported to and from between the chamber 110 and the exterior while the gate valve 114 is opened.

A susceptor 115 is provided in generally the center of the chamber 110. The susceptor 115 is constituted by a conductor such as aluminum, etc., and constitutes a lower electrode of a parallel plate electrode. The wafer W is placed on the upper surface of the susceptor 115.

The susceptor 115 is provided on a stage 117 which is supported by a shaft 116. The shaft 11 is provided so as to penetrate through an opening formed in the bottom surface of the chamber 110. The shaft 116 is connected to an unillustrated elevation mechanism in order to elevate up and down the susceptor 115 together with the stage 117. The shaft 116 is formed to be hollow in its interior, so that a wire or the like is inserted through the interior.

The lower portion of the stage 117 is covered with a bellows 118 made of stainless steel or the like. The bellows 118 has its upper end and lower end threadedly fixed on he lower portion of the stage 117 and the bottom surface of the chamber 110 respectively. The bellows 118 extends or shrinks in accordance with the up and down of the stage 117 to maintain the airtightness in the chamber 110.

A first high frequency power source 119 is connected to the susceptor 115. The first high frequency power source 119 has a frequency ranging from 1 to 13 MHz.

A shower head 120 is provided above the susceptor 115. The shower head 120 is provided so as to face the susceptor 115 in parallel therewith, and has an electrode plate 121 on its surface facing the susceptor 115.

The electrode plate 121 is constituted by a circular-plate-shaped member made of a conductor, and has multiple gas holes 121a over its entire surface. A second high frequency power source 122 is connected to the electrode plate 121. The second high frequency power source 122 has a frequency ranging from 13 to 150 MHz. The electrode plate 121 constitutes a pair of opposing electrodes of the parallel plate electrode together with the susceptor 115.

The shower head 120 comprises a hollow portion 120a which is continuous to the gas holes 121a of the electrode plate 121. Further, the shower head 120 is connected to a gas supply duct 123. The gas supply duct 123 is connected to a gas source 125 via a mass flow controller (MFC) 124. A gas supplied from the gas source 125 is supplied into the hollow portion 120a of the shower head 120 while controlled by the MFC 124 to a predetermined flow rate, and then ejected into the chamber 110 from the gas holes 121a.

A process gas and a carrier gas necessary for a plasma CVD process are supplied from the gas source 125. At the time of forming a film, a predetermined high frequency voltage is applied to the susceptor 115 and the electrode plate 121, thereby a plasma of the gas is generated in the space between the two members. A predetermined CVD film is formed on the surface of the wafer W by activators in the plasma.

Further, the machine 15 comprises a time counter 126. The time counter 126 counts the time during which the machine 15 is on. The counted time is accumulated in a machine condition DB as an Uptime, as will be described later.

The machine 15 comprises a central processing unit 127 constituted by a microcomputer, a memory, and the like. The central processing unit 127 sends a signal for controlling the entire operation of the machine 15.

While the machine 15 is operating, the central processing unit 127 is connected to the APC 112 to sense the internal pressure of the chamber 110 and maintain the pressure within a predetermined range. Further, the central processing unit 127 is connected to the MFC 124 to adjust the flow rate of the gas to be supplied to the chamber 110 to a predetermined rate. In this manner, the central processing unit 127 controls the reaction via the APC 112, the MFC 124 and the like, and at the same time acquires information inside the chamber 110.

The machine 15 may further comprise a temperature sensor for sensing the temperature of the wafer W, a wafer counter for counting the number of wafers W processed, a particle counter for counting the amount of particles in the chamber 110, etc. so that the central processing unit 127 may acquire other data.

The central processing unit 127 stores operational condition data regarding these operational conditions of the machine 15 in a storage unit 128, and also sends the data to the plant computer 16 via a communication unit 129. Although the storage unit 128 is set in the machine 15 in the drawing, the storage unit 128 may be separated from the machine 15 and provided in, for example, the computer 16 shown in FIG. 1.

Further, the machine 15 comprises an input output control unit 130 which is connected to the central processing unit 127. The input output control unit 130 is connected to an input output device 131 including a display screen, a keyboard, etc. The input output device 131 serves as a human interface. The workers in the plant 12 input predetermined control information such as set conditions or the like from the input output device 131, and read information representing a condition of the machine 15 as an output.

Further, the workers input data regarding maintenance works performed for the machine 15 from the input output device. For example, when a worker replaces components due to a trouble or regularly, the worker inputs information regarding maintenance of the machine 15 such as the date of replacement, the kind of the components, the time period of usage, etc. The input information is stored in the storage unit 128 as maintenance data.

The maintenance data includes other log data irrelevant to the maintenance. The log data is a history of all kinds of operations of the machine 15 which is cumulated together with time stamps, and represents what kind of operation is made by a worker of the plant 12 to the machine 15, when and how a sensor of the machine 15 works, when a routine of what kind is initiated by software of the machine 15, when data of what kind is stored in the storage unit 128, etc.

As to the maintenance data input from the input output device 131 likewise, the central processing unit 127 stores it in the storage unit 128 and sends it to the plant computer 16.

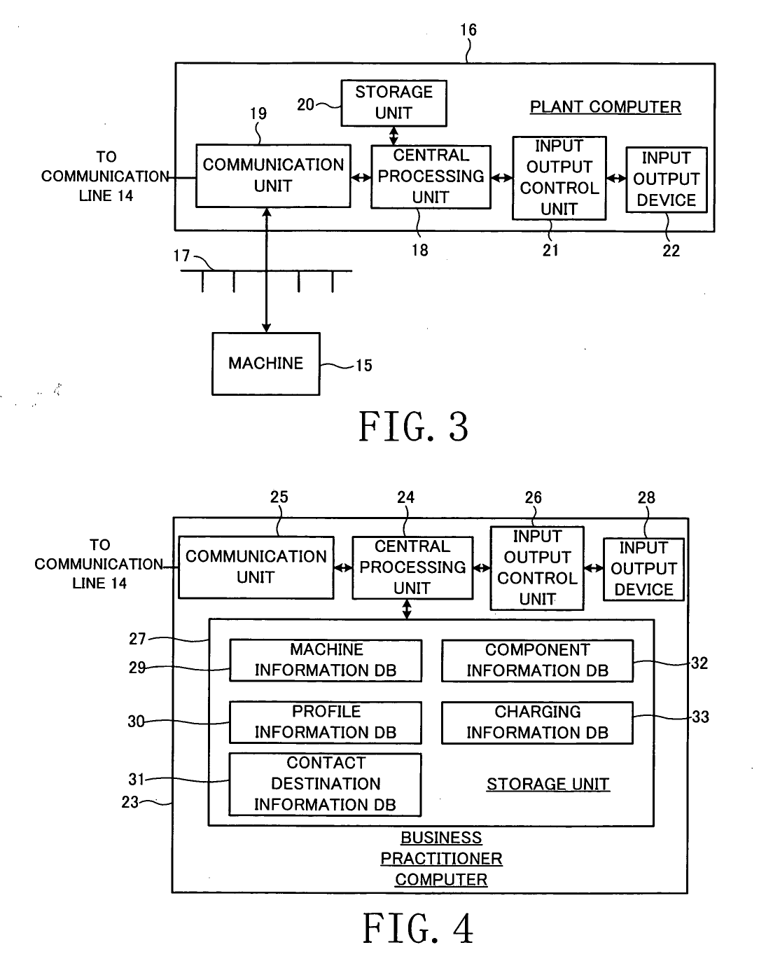

FIG. 3 shows the structure of the plant computer 16. As shown in FIG. 3, the plant computer 16 comprises a central processing unit 18, a communication unit 19, a storage unit 20, and an input output control unit 21.

The central processing unit 18 is constituted by a microcomputer, a memory, and the like, and controls the operation of the plant computer 16.

The communication unit 19 functions as the interface of the plant computer 16 towards the intra-plant wire network 17 and the communication line 14. The central processing unit 18 sends and receives information to and from the machine 15 and the like within the plant 12 via the communication unit 19.

The central processing unit 18 sends operational condition data and maintenance data received from the machine 15 to a later—described business practitioner computer via the communication unit 19. The operational condition data is sent to the business practitioner computer substantially in real time, and the maintenance data is sent thereto as the data occurs or at each predetermined interval.

The storage unit 20 stores the operational condition data and the maintenance data. The central processing unit 18 stores the above-described data received from the machine 15 via the intra-plant wire network 17 in the storage unit 20.

The storage unit 20 may store the above-described data having the same contents as those stored in the storage unit 128 of the machine 15, or may cumulate data of a longer span than the storage unit 128 of the machine 15. Or, the above-described data may be stored in either the storage unit 128 of the machine 15 or the storage unit 20 of the plant computer 16.

The input output control unit 21 is connected to an input output device 22 including display screen, a keyboard, etc. The input output device 22 functions as the human interface. The workers in the plant 12 control the plant computer 16 and the machine 15 from the input output device 22 and acquire information regarding the machine 15, etc.

When a trouble occurs, for example, a worker of the user side receives information on how to cope with the trouble from the business practitioner via the input output device 22 of the plant computer 16, and carries out necessary measures.

The plant computer 16 keeps the machine 15 on all the time and prepared for manufacturing anytime except an Unscheduled Downtime by occurrence of a trouble and the like and a Scheduled Downtime for a regular checkup and the like.

The plant computer 16 controls the machine 15 to perform a test operation at each predetermined time interval while the machine 15 is in a standby state where it does not perform a manufacturing operation. At this time, the machine 15 performs a normal film forming operation on a dummy wafer in accordance with a predetermined test program. When an abnormal condition is detected in the test operation, the plant computer 16 turns off the machine 15 if necessary, and performs a recovery process. At the time of test operation too, the later-described business practitioner computer monitors the operational state of the machine 15 and notifies the user of any abnormal condition if such a condition is detected.

As described above, the time counter 126 counts the time during which the machine 15 is on. That is, the time counter 126 counts the time during which the machine 15 is actually operating properly and is in a state where it can operate properly. The time during which the machine 15 is actually operating properly and is in a state where it can operate properly is herein represented as “Uptime”.

Returning to FIG. 1, a business practitioner computer 23 is installed at the business practitioner's office 13 of the business practitioner. FIG. 4 shows the structure of the business practitioner computer 23. As shown in FIG. 4, the business practitioner computer 23 comprises a central processing unit 24, a communication unit 25, an input output control unit 26, and a storage unit 27.

The central processing unit 24 is constituted by a microcomputer, a memory, and the like, and controls the operation of the business practitioner computer 23.

The communication unit 25 functions as an external interface on the side of the business practitioner computer 23. The central processing unit 24 sends and receives information to and from one or a plurality of plant computers 16 via the communication unit 25.

The input output control unit 26 is connected to an input output device 28 comprising a screen, a keyboard, and the like. The input output device 28 functions as the human interface. An operator of the business practitioner side controls the business practitioner computer 23 by performing a predetermined inputting operation from the input output device 28. A worker at the business practitioner sends coping information by e-mail or the like to the user from the input output device 28, and checks the operational condition of the machine 15.

The storage unit 27 comprises various database (DB). The storage unit 27 comprises a machine information DB 29, a profile information DB 30, a contact destination information DB 31, a component information DB 32, and a charging information DB 33.

In the machine information DB 29, operational condition data and maintenance data of the machine 15 which is the objective of the maintenance service, are cumulated per machine 15. The machine information DB 29 is classified, for example, user by user or plant 12 by plant 12.

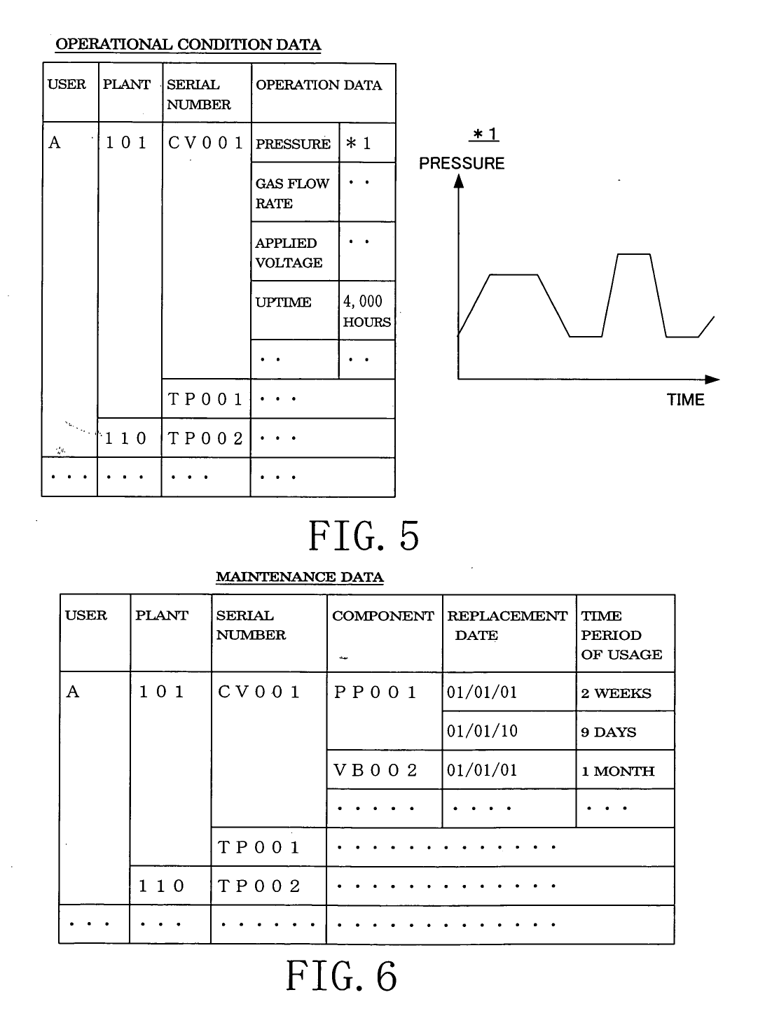

FIG. 5 shows one example of operational condition data stored in the machine information DB 29. In the example shown in FIG. 5, operational condition data of the machine 15 is cumulated in the form shown by *1 in FIG. 5 in the machine information DB 29.

The operational condition data includes the Uptime of the machine 15 acquired from the time counter 126 of the machine 15. As described above, the Uptime represents the time during which the machine 15 is on. The time counter 126 is reset in, for example, each unit charging period to be described later, and thus the value indicated by the time counter 126 represents the Uptime in a unit charging period.

The Uptime includes not only the time (Productive Time) during which the machine 15 is actually performing manufacturing, but also the time (Standby Time) during which the machine 15 is not performing manufacturing but is on standby for manufacturing. In the opening time of the plant 12, the machine 15 is always kept on and is on standby in order to be able to quickly respond to a sudden order from a customer even when it is not performing manufacturing. As described above, the Uptime includes the Productive Time and the Standby Time, and thus is constituted by a time during which the machine 15 is on.

FIG. 6 shows one example of maintenance data stored in the machine information DB 29. In the example shown in FIG. 6, maintenance data regarding components replacement is cumulated in the machine information DB 29 per kind. The maintenance data includes date (time) of replacement, total time period of usage, etc. per component.

The profile information DB 30 stores standard profiles of parameters (temperature, pressure, etc.) for each manufacturing step, which present the recipe of operations of the machine 15.

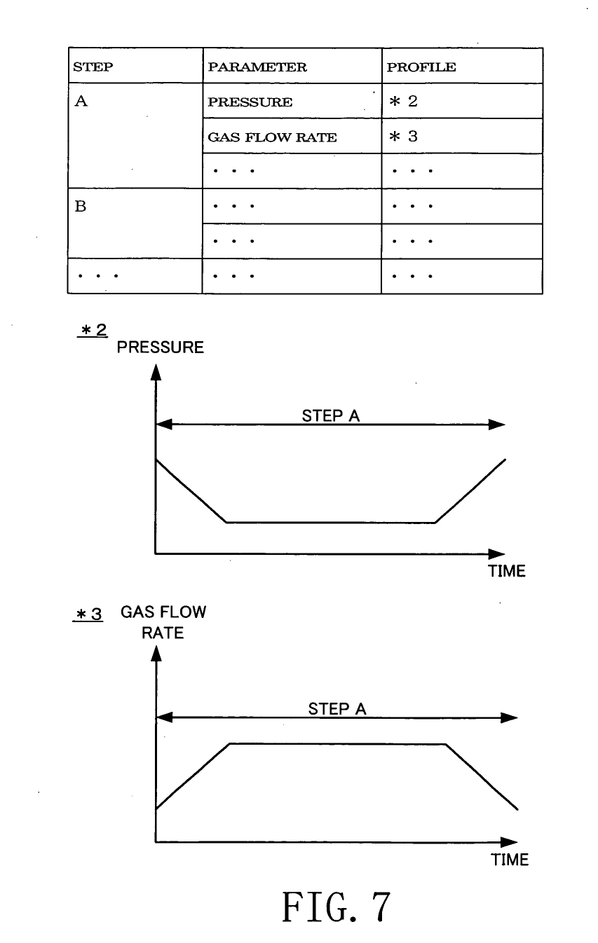

FIG. 7 shows one example of standard profiles of respective parameters for steps A, B, . . . stored in the profile information DB 30. In the example shown in FIG. 7, pressure, gas flow rate, etc. are stored in the form shown by *2 and *3 as variable parameters for the step A.

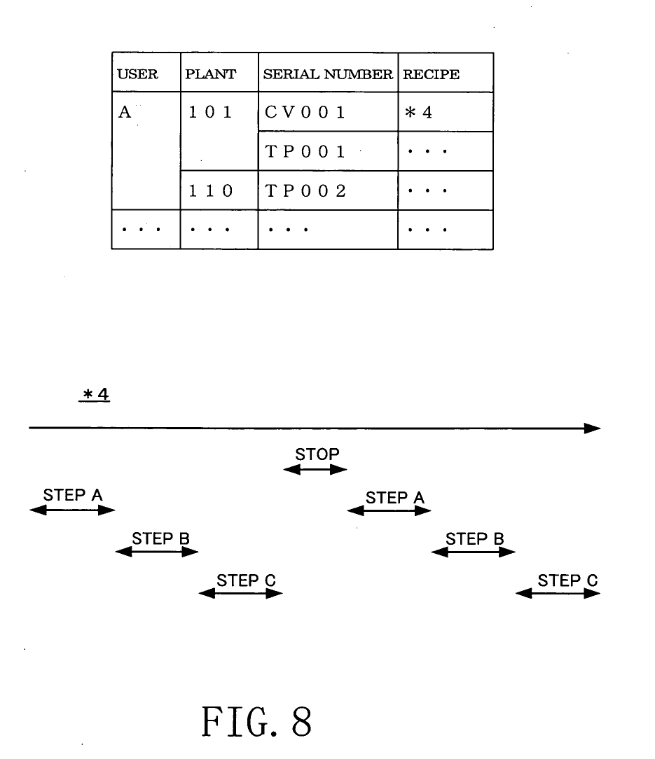

Further, in the profile information DB 30, a manufacturing step table (recipe) for a redetermined process of each machine 15 is stored, as shown in FIG. 8. The recipe is previously notified from the user to the business practitioner automatically via the communication line 14, or via a man. The recipe is stored, for example, in the form shown by *4.

The recipe and the reference profile stored in the profile information DB 30 are used for later-described monitoring of the operational condition of the machine 15 by the plant computer 16.

To be more specific, the central processing unit 24 reads out a standard profile shown in FIG. 7 for each parameter in accordance with the recipe shown in FIG. 8. The business practitioner computer 23 (central processing unit 24) compares a change profile of each parameter in the actual operational condition data received from the machine 15 with the read standard profile, and determines the condition of the machine 15.

In a case where the actual change profile of each parameter and the standard profile are not within an error range of 5%, the business practitioner computer 23 determines that the machine 15 is in an abnormal condition.

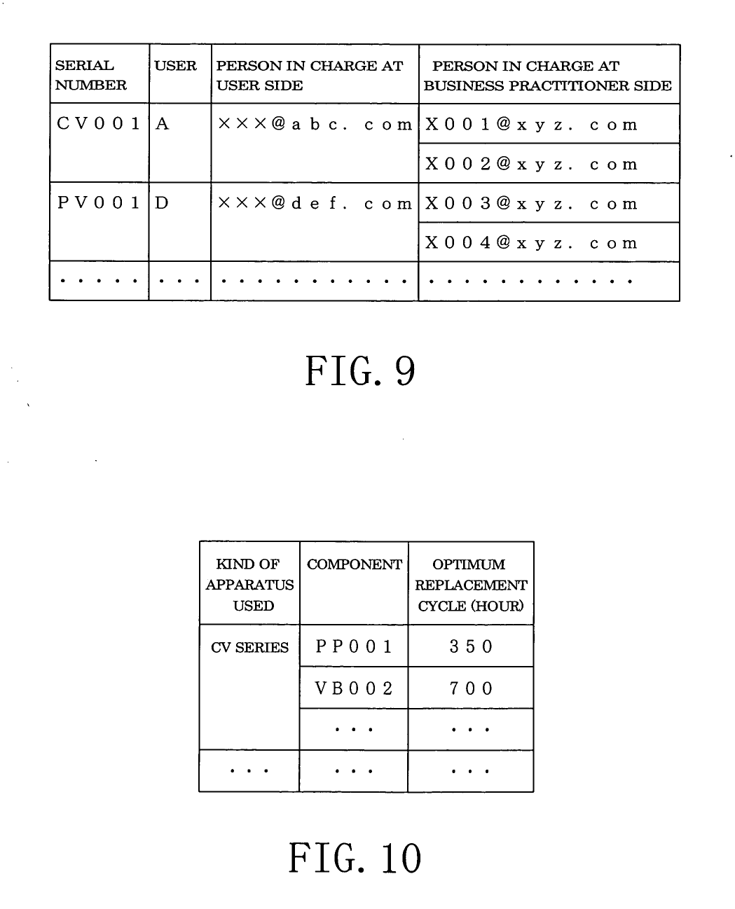

The contact destination information DB 31 stores a contact destination (e-mail address, etc.) of the workers at the user side and the workers at the business practitioner side. FIG. 9 shows one example of this. In the contact destination information DB 31 shown in FIG. 9, there is a link to the e-mail address of a person (at the user side and at the business practitioner side) who is in charge of the maintenance of a machine 15 per machine 15.

In the component information DB 32, the optimum replacement cycle of each component constituting the machine 15 is stored. FIG. 10 shows one example of the component information DB 32. As shown in FIG. 10, the optimum replacement cycle of the constituent component is stored in the component information DB 32 for each kind of the machine 15.

The optimum replacement cycle is a period of time which is recommended by the business practitioner and during which the component can be used stably. The optimum replacement cycle is a value which is optimized based on component replacement data which occurs in the actual use scene. For example, the optimum replacement cycle is an average value of the time periods of use of the component which are collected as maintenance data, or a value obtained by adding a predetermined margin to the average value. The optimization method is not limited to this.

In the optimization, data of a higher reliability can be obtained as the amount of data is larger. Accordingly, an optimum replacement cycle which is calculated based on data collected from one or a plurality of users has a higher reliability than one calculated by, for example, a user solely.

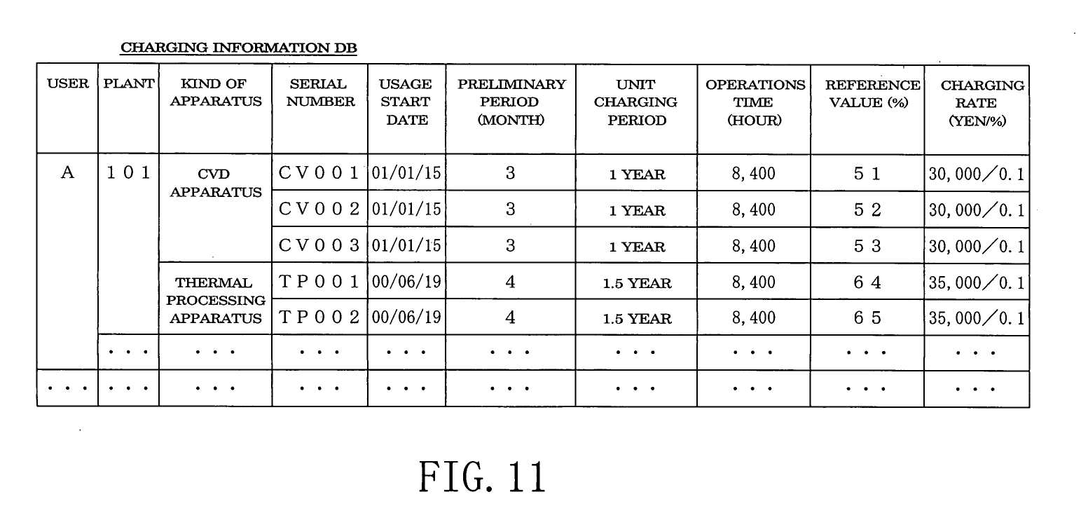

The charging information DB 33 stores various data used in a charge amount determining process for the maintenance service. FIG. 11 shows an example of data stored in the charging information DB 33. In the example shown in FIG. 11, data regarding the kind of the machine 15 used, serial number, usage start date, preliminary period, unit charging period, Operations Time, productivity reference value, and charging rate are stored for each user.

These information pieces represent prearranged values which are determined in an agreement between the user and the business practitioner, and are input to the business practitioner computer 23 before a charge amount is determined.

The usage start date represents a date and time on and at which the actual operation of the machine 15 is started, or the date and time on and at which the maintenance service is started. Based on the usage start time, an arrival of a deadline of the later-described preliminary period and unit charging period is determined.

The preliminary period is a period for determining the later-described productivity reference value, and is a preparatory period before the maintenance service is started. The preliminary period is a predetermined period after the usage start date of the machine 15, or a predetermined period before the maintenance service is fully started, and lasts for, for example, three months.

In the preliminary period, the maintenance of the machine 15 is basically fulfilled by he user. When a trouble happens, the business practitioner carries out their works in response to a notice from the user. Although the business practitioner acquires operational information of the machine 15 via the communication line 14 and cumulates various data, they stand up for coping after a notice is given from the user. As described above, the maintenance during the preliminary period is mainly done by the user, so that contribution of the business practitioner is minimized.

The unit charging period represents a period for which the business practitioner requires payment, that is, a period during which a charge for the maintenance service occurs, and is set to one year, for example. The unit charging period is started after a preliminary period ends or after a last unit charging period ends, and charging takes place after the unit charging period ends.

The Operations Time is a time during which the machine 15 should be operable within a current unit charging period in the plant 12 of the user. The Operations Time is, for example, a value which is preset based on the opening schedule of the plant 12 of the user where the machine 15 is arranged, and is set to 8,400 hours (350 days) in the example shown in the drawing.

A charge amount is determined by using an Availability which quantifies the productivity in a unit charging period. The Availability is the ratio of the Uptime to the Operations Time in a unit charging period, and is calculated by (Uptime)/(Operations Time)×100(%). The Uptime is stored in the machine information DB 29.

In the present specification, the Availability is different from a so-called Utilization. The Utilization represents a ratio of a Productive Time to Operations Time. On the other hand, the Uptime in the above-described formula used for calculation of the Availability includes the Standby Time, etc. which does not contribute to the manufacture. Accordingly, the Availability represents a ratio of “a time during which the machine can be operated” within the Operations Time.

The productivity reference value is used as a reference for calculating a charge amount. The productivity reference value is determined by quantifying the productivity of the machine 15 in the above-described preliminary period. The productivity reference value is determined by using the same quantification method as in the charging target period, and is determined as an Availability. The Availability is calculated by the same method as in the above-described unit charging period, based on an Operations Time and Uptime in the preliminary period.

A charge amount is determined by comparing the quantified productivity (Availability) in a unit charging period with the productivity reference value. As described above, in the preliminary period, the maintenance is mainly fulfilled by the user such that contribution of the business practitioner is minimized. On the other hand, in the unit charging period, the maintenance is fulfilled by the user and the business practitioner in cooperation with each other.

By comparing the productivity (reference value) in the preliminary period and the productivity (actual measurement) in the charging target period, it is possible to quantify a change in the productivity corresponding to the contribution of the business practitioner in the maintenance in the charging target period. In the present example, the business practitioner makes a charge only in a case where the productivity is improved, and charges an amount which is in proportion to the improvement achieved.

The charging rate is a rate for converting the difference (improvement) between the actually measured productivity in the charging target period and the productivity reference into a charge amount. For example, in a case where the Availability in the charging target period is 56% and the reference value is 51%, the difference representing the quantified improvement in the productivity is 5%. In a case where the charging rate is, for example, 30,000 yen/%, the charge amount for the corresponding machine 15 is determined to be 150,000 yen by multiplication of the rate.

The charging rate is arranged between the business practitioner and the user. The charging rate is determined based on the kind of machine, number of years of usage, number of years for contract, etc. In the example shown in the drawing, the charging rate is set for each kind of machine.

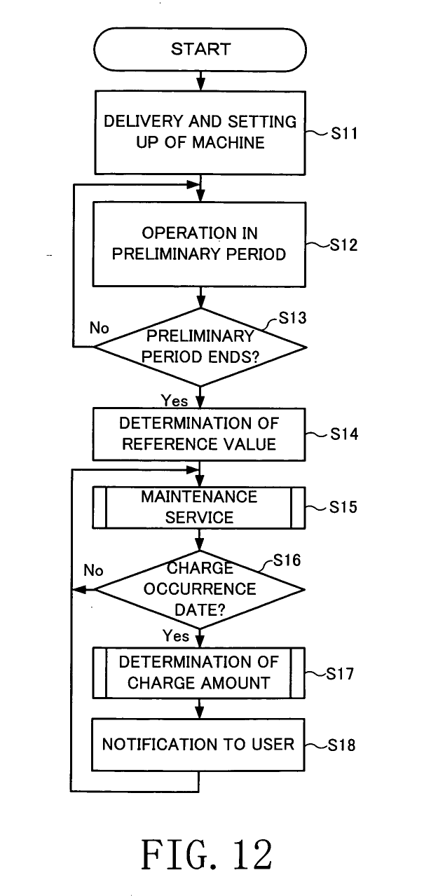

The operation of the above charging system 11 will now be explained with reference to the drawings. FIG. 12 to FIG. 15 show the flow of the operation of the business practitioner computer 23 (in particular the central processing unit 24). The flow shown in FIG. 12 to FIG. 15 is an example, and anything that has the same effect may thus be applicable.

First, the machine 15 is delivered to the plant 12 of the user, and is set up for operation. When the machine 15 exhibits a predetermined function, a receiving inspection is carried out (step S11). After the receiving inspection, the actual operation of the machine 15 is started. This date and time are stored in the charging information DB 33 as the usage start date.

Meanwhile, the user closes a contract with the business practitioner who provides the maintenance service for the machine 15, and the maintenance service is started along with the start of the operation of the machine 15. At this time, the method of determining the charge amount is arranged between the user and the business practitioner. That is, the method of setting the reference value and the preliminary period for this setting, the unit charging target period, the charging rate, etc. are determined. These information pieces are input to the business practitioner computer 23 and is stored in the charging information DB 33.

The business practitioner carries out maintenance works for a predetermined period, for example, for three months from the start of operation of the machine 15 as the preliminary period (step S12). During this preliminary period, the maintenance is carried out basically by the user and the business practitioner works in response to a notice from the user when a trouble happens. Although the business practitioner acquires operational information of the machine 15 via the communication line 14 and stores various data, they only respond to troubles when there is a notice from the user. In this way, the maintenance is carried out in the preliminary period to aim for maintaining the productivity of the machine 15 at a predetermined level.

After the preliminary period ends (step S13, Yes), the business practitioner calculates the Availability in this preliminary period (step S14). The Availability is calculated as a ratio (%) obtained by dividing the Uptime of the machine 15 in the preliminary period by the Operations Time, as described above. The calculated reference value is stored in the charging information DB 33 as the productivity reference value.

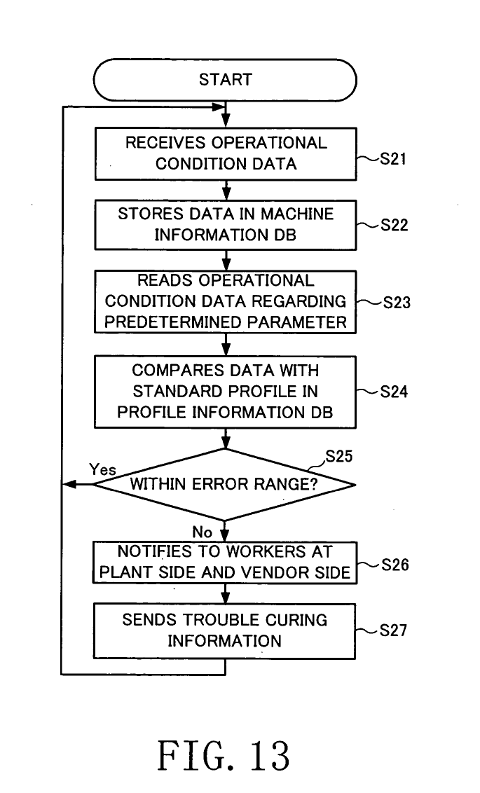

After the preliminary period ends, the business practitioner starts the “essential” maintenance work such as starting monitoring the machine 15 in real time, in a way described below (step S15). FIG. 13 shows one example of the flow of a monitoring operation.

The business practitioner computer 23 receives operational condition data of the machine 15 in real time (step S21). The business practitioner computer 23 stores the received operational condition data in the machine information DB 29 (step S22).

The business practitioner computer 23 reads out a predetermined parameter, for example, operational condition data (change profile) based on temperature in the received operational condition data from the machine information DB 29 (step S23).

The business practitioner computer 23 refers to a standard profile regarding temperature stored in the profile information DB 30, and compares it with the profile of the operational condition data (step S24). The business practitioner computer 23 determines whether or not the difference between the actually measured profile and the standard profile is within a predetermined error range (for example, 5%) (step S25).

The above process is performed not only for the temperature parameter, but at the same time for the other parameters obtained from the machine 15 such as pressure, etc.

In a case where determining that the difference between the actually measured profile and the standard profile is within the predetermined error range (step S25; Yes), the business practitioner computer 23 receives operational condition data and keeps monitoring the machine 15.

On the contrary, in a case where determining that the difference between the both is not within the above-described range (step S25; No), the business practitioner computer 23 determines that a trouble occurs in the machine 15. At this time, the business practitioner computer 23 notifies the occurrence of the trouble and its condition to the user via the input output device of the plant computer 16 (step S26). At the same time, the business practitioner computer 23 reads contact destination information such as the e-mail address, etc. of the person in charge of the maintenance at the maker (user) side from the contact destination information DB 31, and sends as an e-mail or the like for notifying the occurrence of the trouble to the contact destination.

In a case where an abnormal condition is detected in the operational condition, the business practitioner computer 23 refers to the contact destination information DB 31 and notifies the occurrence of the trouble and its content to the user (plant 12) side and to the business practitioner side. A worker at the user side checks the condition of the machine 15 based on the notification, and takes necessary measures. Further, a worker in charge at the business practitioner side heads for the plant 12 where the troubling machine 15 is used based on the notification, bringing a replacement component with him/her if necessary, and performs a repairing work.

Further, the business practitioner computer 23 notifies the occurrence of the trouble and its condition also to the operator or the like of the business practitioner via the input output device of the business practitioner computer 23. At the same time, the business practitioner computer 23 reads contact destination information such as the e-mail address or the like of the person in charge of maintenance at the business practitioner side from the contact destination information DB 31, and sends an e-mail or the like for notifying the occurrence of the trouble to the contact destination.

The workers at the user side and business practitioner side perform trouble curing processes based on the notification from the business practitioner computer 23. The means for notifying to the persons in charge at the user side and business practitioner side is not limited to an e-mail, but may be a cellular phone, a beeper, a hand-held computer, etc.

The business practitioner computer 23 notifies the occurrence of the trouble, and at the same time, sends information necessary for trouble curing to those concerned (step S27). The workers at the user side and business practitioner side perform repairing processes based on the received trouble curing information.

At this time, the time counter 126 stops counting at the time the machine 15 is turned off for the repairing processes.

In a case where determining that the profile of the data regarding, for example, the pressure inside the chamber 110 is abnormal, the business practitioner computer 23 notifies the fact to the worker at the user side, etc. to give an instruction for correcting the temperature.

If the abnormality is not cured despite the works of the workers, the business practitioner computer 23 specifies the cause based on a report or the like from the workers, and notifies the cause to the workers. For example, in a case where the pressure does not reach a predetermined value in any way, the business practitioner computer 23 gives an instruction for a checkup and replacement of the APC 112 and the vacuum pump 113.

Further, in a case where the trouble is a problem in the software, for example, the business practitioner computer 23 sends predetermined software to the plant computer 16 so that the plant computer 16 automatically performs a recovery process.

When the machine 15 is turned on after the recovery process is completed, the time counter 126 starts counting. In this manner, the time counter 126 counts the Uptime which does not include an unexpected (unscheduled) Unscheduled Downtime of the machine 15.

As described above, by the user and the business practitioner performing the maintenance in cooperation, it is possible to substantially shorten the (unscheduled) Unscheduled Downtime of the machine 15 when a trouble occurs, due to elimination of redundancy of works, and shortening of a waiting time of the worker at the user side, etc. Accordingly, it is possible to improve the Availability (productivity) of the machine 15.

While monitoring the machine 15 by receiving the operational condition data as described above, the business practitioner computer 23 receives maintenance data, calculates an optimum replacement cycle for a component in a way described below, and stores the optimum replacement cycle in the component information DB 32.

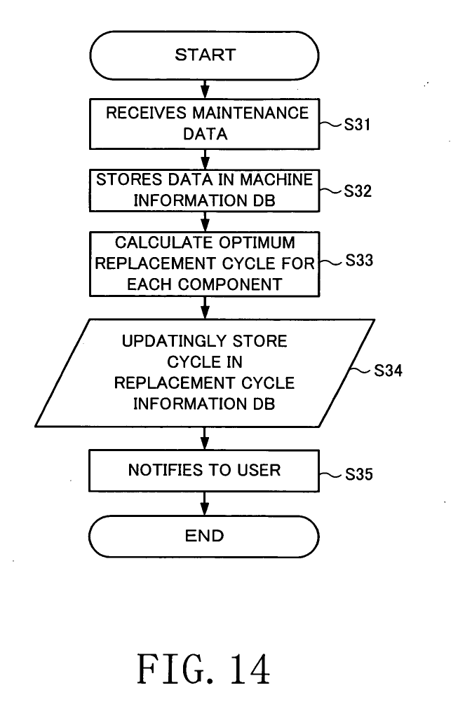

The operation of the business practitioner computer 23 for processing the maintenance data will now be explained with reference to the flow shown in FIG. 14.

Data regarding replacement of components of the machine 15 which is included in the maintenance data is generated when components are replaced at the time of a regular checkup of the machine 15, or when a trouble due to a component occurs and the component is repaired or replaced. That is, the data is generated by the worker who conducts the components replacement inputting maintenance data such as the kind of the replaced components, the date, the time period of usage, etc. from the input output device of the machine 15. The generated data is sent by the plant computer 16 immediately after the generation or regularly, and the business practitioner computer 23 receives the data (step S31).

When the machine 15 is stopped for components replacement due to an unexpected trouble and for a regular replacement, the time counter 126 stops counting. Accordingly, the time counter 126 counts the Uptime of the machine 15 which does not include the Scheduled Downtime and the Unscheduled Downtime.

The central processing unit 127 of the business practitioner computer 23 stores the received maintenance data in the machine information DB 29 (step S32). Then, the business practitioner computer 23 refers to the kind of components replaced from the maintenance data in the machine information DB 29, and calculates the optimum replacement cycle of the corresponding component (step S33).

The optimum replacement cycle is an average value of collected time periods of use of the component or a value obtained by adding a predetermined margin or a weight to the average value. That is, the optimum replacement cycle is derived by calculating the average time period of usage of the replaced component and adding a predetermined margin thereto. This process is performed each time new maintenance data (components replacement data) is generated, and the derived optimum replacement cycle is updatingly stored in the component information DB 32.

In this way, the optimum replacement cycle for components stored in the component information DB 32 is more optimized as components replacement is conducted on many machines 15 and each time new maintenance data is obtained.

The business practitioner computer 23 collects maintenance data from machines 15 possessed by one or a plurality of users. Accordingly, the replacement cycle of components is a highly reliable one that is based on ample data.

The optimum replacement cycle for each kind of component which is obtained in the way described above is sent to all the users regularly, for example, every one or two week(s) (step S35). The user can work out a new plan that enables more efficient operation of the machine 15 and the plant 12 by referring to the received replacement cycle information. As a result, the productivity of the machine 15 can be improved due to that the cycle for the regular checkup can be optimized and an increase of the Operations Time of the machine 15 and a reduction in the Scheduled Downtime of the machine 15 can be achieved, etc.

Returning to FIG. 12, the business practitioner computer 23 performs the monitoring operation and the like in the way described above. As the reward for those maintenance services, the business practitioner computer 23 determines a charge amount corresponding to the improvement in the productivity in each unit charging target period, and charges the charge amount to the user.

The business practitioner computer 23 determines whether or not a charge occurrence date comes based on the usage start date of the machine 15 and the unit charging period and/or the preliminary period which are stored in the charging information DB 33 (step S16). The charge occurrence date is a year and three months after the usage start date, in a case where the preliminary period is three months and the unit charging period is a year. A deadline computed by adding the preliminary period to the usage start date may be pre-stored in the charging information DB 33 as a service start date, and a charge occurrence may be determined at intervals of each unit time period after the service start date.

In the flow shown in FIG. 12, the monitoring process and the charge amount determining process are separately performed. However, the monitoring process and the charge amount determining process are performed substantially in parallel.

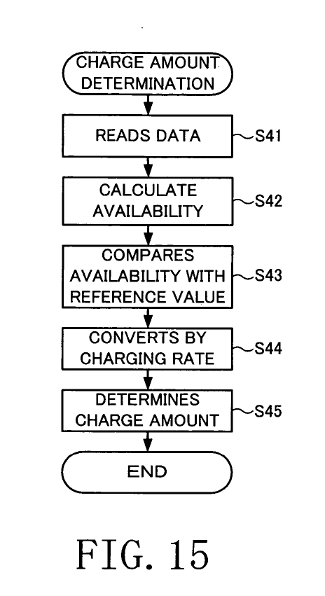

When the charge occurrence date comes, the business computer practitioner 23 determines the charge amount for the last unit charging period which has expired (step S17). FIG. 15 shows an example of the flow representing the operation for determining the charge amount.

First, the business practitioner computer 23 reads the Uptime of the machine 15 which is in the charging period from the machine information DB 29, while reading the Operations Time of the machine 15 from the profile information DB 30 (step S41). The Uptime in the machine information DB 29 and the Operations Time in the profile information DB 30 are respectively reset after the charge amount is determined.

The business practitioner computer 23 calculates the Availability based on the read Uptime and Operations Time (step S42). Specifically, the business practitioner computer 23 divides the Uptime by the Operations Time. The Availability (%) is derived by multiplying the obtained value by 100.

Next, the business practitioner computer 23 refers to the productivity reference value (Availability) in the charging information DB 33, and compares it with the calculated Availability (step S43). That is, the difference between the calculated value and the reference value is calculated. The obtained difference is the quantified improvement in the productivity of the machine 15 in the charging target period, and a charge is made for the difference.

Next, the business practitioner computer 23 refers to the charging rate in the charging information DB 33, and converts the quantified improvement in the productivity by multiplying it by the charging rate (step S44). As a result, the charge amount for the maintenance service for the machine 15 in the target period and corresponding to the improvement in the productivity is determined (step S45).

In a case where no improvement is observed in the productivity, a charge does not occur. That is, in a case where, for example, the difference takes a negative value, a charge does not occur.

The business practitioner computer 23 performs the same process as described above, for the machines 15 for which the predetermined charging target period passes after the usage start, based on the usage start date in the machine information DB 29.

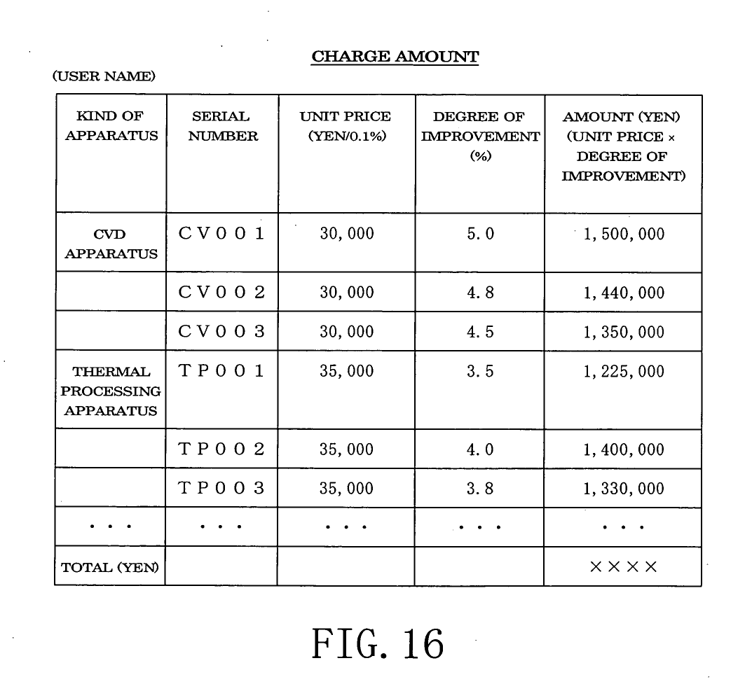

The business practitioner computer 23 notifies the user of the result obtained in the way described above as the charge amount (FIG. 12, step S18). The notification is notified to the user at each occurrence of a result, or at each end of a term. The notification method includes means such as e-mail, FAX, etc. and the user is notified in a form as shown in FIG. 16, for example.

The user who receives a bill as shown in the drawing can clearly understand that the productivity of the machine 15 is improved by the maintenance service and the charge is made for the improvement. Since the charge occurs correspondingly to the improvement of the productivity, an unrewarded increase in the cost due to the payment for the price of the service can be avoided, and the user can be satisfied with the charge for the price.

As described above, in the present embodiment, a charge is made selectively for the improvement in the productivity of the machine 15 due to the maintenance service. Further, the charge amount is an amount corresponding to the degree of improvement in he productivity. As such, since a charge can be made for the improvement in the productivity separately from a charge for the general maintenance service, this is a charging method satisfying for both of the user and the business practitioner.

That is, the user pays for the maintenance service correspondingly to the improvement in the productivity, and thus can save an increase in the manufacturing cost due to an increase in the maintenance fee.

The business practitioner can collect a charge for carrying out such a high-quality maintenance service as described above in a such way as satisfying for the user without sacrificing the customer satisfaction.

The present invention is not limited to the above-described embodiment, but various modifications and applications are available. A modification of the above-described embodiment which is applicable to the present invention will now be explained.

In the above-described embodiment, the productivity reference value, the unit charging period, the productivity reference value, the charging rate, etc. stored in the charging information DB 33 are fixed. However, needless to say, these data pieces may be changeable at an arbitrary time in accordance with arrangements, etc. between the user and the business practitioner. For example, as the number of years of usage of the machine 15 increases, the productivity reference value, the charging rate, etc. may be gradually decreased.

In the above-described embodiment, the productivity reference value is determined by preparing the preliminary period and quantifying the productivity in this period. However, the method of setting the reference value is not limited to this. For example, a value which is prearranged by the user and the business practitioner may be used.

In the above-described embodiment, the productivity is quantified based on the Availability. However, in the quantification method, the Availability, the Uptime, an mount of processing output per unit period, or combination of those may be used.

The structure of the above-described embodiment is such that the time counter 126 is provided in the machine 15. However, the time counter 126 may be provided in the plant computer 16, or may be constituted by a software timer built in the plant computer 16.

In the above-described embodiment, the time during which the machine 15 is on is counted as the Uptime. However, the way in which the Uptime is set is not limited to his, but the Uptime may be counted by counting the time except the time during which the machine 15 substantially completes the processing operations. Furthermore, the Uptime may be calculated by counting the time during which the machine 15 is off not the time during which the machine 15 is on and subtracting the counted time from the Operations Time.

Further, in the above-described example, the machine 15 is in the on state all the time even in a time during which it is not operated for manufacturing, and performs a test operation at each predetermined time interval. However, the present invention is not limited to this, but the machine 15 may basically be turned off when it is not operated for manufacturing, and may be turned on for test operation at each predetermined time interval. In this case, the time counter 126 keeps counting even when the time for the last operation for manufacturing changes to the off state as if the machine 15 were in the on state, and stops counting at the time an abnormal condition is detected in the test operation, for example.

In the above-described embodiment, the maintenance data regarding the components replacement is input from the input output device provided to the machine 15. However, the present invention is not limited to this, but the maintenance data may be input from the plant computer 16, and sent to the business practitioner computer 23. Further, the operational condition data and the maintenance data sent from the machine 15 are sent to the business practitioner computer 23 via the intra-plant wire network 17. However, the machine 15 may be directly connected to the communication line 14 such as the Internet or the like, and the data may be directly sent to the business practitioner computer 23.

In the above-described embodiment, the business practitioner computer 23 derives the optimum replacement cycle for components based on collected maintenance data, databases the derived cycle, and sends it to the user regularly. The databased optimum replacement cycle for components may be so structured as to be opened and searchable on the Internet, by equipping the business practitioner computer 23 and the plant computer 16 with a specialized browser.

Further, in the above-described example, the plant computer 16 sends various data to the business practitioner computer 23. However, the business practitioner computer 23 may access the plant computer 16 to acquire the operational condition data and the maintenance data.

In the above-described embodiment, the user is a semiconductor device maker or the like, and the machine 15 used by the user is a machine for manufacturing semiconductor devices, liquid crystal display devices, etc. However, the present invention is not limited to this, but may be applied to a machine for manufacturing other electronic devices such as CCDs, solar cells, etc. and other general industrial products.

This application is based on Japanese Patent Application No. 2002-265664 filed on Sep. 11, 2002 and including specification, claims, drawings and summary. The disclosure of the above Application is incorporated herein by reference in its entirety.

### INDUSTRIAL APPLICABILITY

The present invention can be applied to industrial fields where a charging method and a charging system for a maintenance service for manufacturing machines are used.

According to the present invention, there are provided a charging method and a charging system which can satisfy both of the user and the vendor or the like.

1. A charging method for determining an amount of payment for a maintenance service for a machine (15), comprising:
a quantifying step (S42) of quantifying productivity of said machine (15) in a predetermined service period;
a comparing step (S43) of comparing the productivity quantified in said quantifying step (S42) with a predetermined productivity reference and calculating a difference between them; and
a charge amount determining step (S45) of determining a charge amount for said maintenance service in said service period based on the difference calculated in said comparing step (S43).

2. The charging method according to claim 1, comprising a productivity reference determining step (S14) of determining said productivity reference by operating said machine (15) during a predetermined preliminary period and quantifying productivity of said machine (15) in said preliminary period.

3. The charging method according to claim 1, wherein in said quantifying step (S42), the productivity of said machine (15) is quantified based on at least one of availability, uptime, and an amount of production.

4. The charging method according to claim 1, wherein in said charge amount determining step (S45), the charge amount is determined by multiplying the calculated difference by a predetermined conversion rate.

5. A charging system for determining an amount of payment for a maintenance service for a machine (15), comprising:
quantifying means for quantifying productivity of said machine (15) in a predetermined service period;
comparing means for comparing the quantified productivity with a predetermined productivity reference and calculating a difference between them; and
charge amount determining means for determining a charge amount for said maintenance service in said service period based on the calculated difference.

6. The charging system according to claim 5, comprising productivity reference determining means for determining the productivity reference by operating said machine (15) during a predetermined preliminary period and quantifying productivity of said machine (15) in said preliminary period.

7. The charging system according to claim 5, wherein said quantifying means quantifies the productivity of said machine (15) based on at least one of availability, uptime, and an amount of production.

8. The charging system according to claim 5, wherein said charge amount determining means determines the charge amount by multiplying the calculated difference by a predetermined conversion rate.
